(19) United States
(12) Patent Application Publication
(10) Pub. No.: US 2021/0050024 A1
(43) Pub. Date: Feb. 18, 2021

(54) Watermarking of Synthetic Speech

(71) Applicant: Nuance Communications, Inc., Burlington, MA (US)

(72) Inventors: Johan Wouters, Burlington, MA (US); Kevin R. Farrell, Medford, MA (US); William F. Ganong, III, Brookline, MA (US)

(21) Appl. No.: 16/538,423

(22) Filed: Aug. 12, 2019

(51) Int. Cl. G10L 19/018; G10L 13/04; G10L 25/84; G10L 19/125

(52) U.S. Cl. CPC G10L 19/018; G10L 19/125; G10L 25/84; G10L 13/043

(57) ABSTRACT

An audio watermark is embedded in synthetic speech, such as synthetic speech created using text-to-speech (TTS) synthesis. Such audio watermarks can, for example, be used to increase the accuracy of voice biometric (VB) and other systems in distinguishing synthetic speech from human speech. In addition to its use in voice biometrics, such audio watermarking can prevent misuse of human quality TTS, or other synthetic speech, in a variety of other contexts, such as incriminating recordings, spam messages, contact center denial of service, and protection of personal information in contact centers not utilizing VB.

### BACKGROUND

The latest deep learning-based text-to-speech (TTS) systems are approaching human quality, and are becoming harder to detect by voice biometric (VB) systems. Perpetrators can record speech of a potential victim and train a TTS system to mimic that person's voice, so that the voice biometric system can be deceived into recognizing the perpetrator's synthetic speech as being that of the victim. Audio samples can then be generated to attack accounts for that user which are protected with voice biometrics.

### SUMMARY

In accordance with an embodiment of the invention, an audio watermark is embedded in synthetic speech, such as synthetic speech created using text-to-speech (TTS) synthesis. Such audio watermarks can, for example, be used to increase the accuracy of voice biometric (VB) and other systems in distinguishing synthetic speech from human speech. In addition to its use in voice biometrics, such audio watermarking can prevent misuse of human quality TTS, or other synthetic speech, in a variety of other contexts, such as incriminating recordings, spam messages, contact center denial of service, and protection of personal information in contact centers not utilizing VB.

One embodiment according to the invention is a computerized method of processing a synthetic speech signal to facilitate distinguishing of the synthetic speech signal from a natural human speech signal. The method comprises, during or after generating the synthetic speech signal, automatically embedding an audio watermark signal into the synthetic speech signal based on an audio watermark key to thereby permit distinguishing of the synthetic speech signal from a natural human speech signal when the audio watermark signal is detected by a machine recipient of the synthetic speech signal in possession of the audio watermark key. The audio watermark signal is imperceptible by natural human audio perception of the synthetic speech signal with the embedded audio watermark signal.

In further, related embodiments, the synthetic speech signal may comprise a text-to-speech (TTS) synthesized signal. In other examples the synthetic speech signal may be another type of synthetic speech signal; and the synthetic speech signal may be a recorded speech signal, or a synthetic speech signal created by voice transformation. Embedding the audio watermark signal may comprise embedding the audio watermark signal based on a phonetic content of the synthetic speech signal. Embedding the audio watermark signal may comprise: (i) embedding the audio watermark signal in a pitch synchronous pattern based on at least one pitch period of the synthetic speech signal, and wherein the audio watermark key comprises the pitch synchronous pattern or comprises information with which the pitch synchronous pattern can be derived or reconstructed; (ii) embedding the audio watermark signal into the synthetic speech signal based on a spectral pattern, and wherein the audio watermark key comprises the spectral pattern or comprises information with which the spectral pattern can be derived or reconstructed; or (iii) embedding the audio watermark signal into the synthetic speech signal based on a frequency hopping sequence, and wherein the audio watermark key comprises the frequency hopping sequence or comprises information with which the frequency hopping pattern can be derived or reconstructed. The audio watermark signal may comprise data regarding a source of the synthetic speech signal. The audio watermark signal may be robust to a level of degradation of the audio watermark signal that is greater than a level of degradation permitted for recognition of the synthetic speech signal by the machine recipient. The computerized method may further comprise varying an information content of the audio watermark signal based on at least one of an information content of the synthetic speech signal, a length of the synthetic speech signal, and a quality of the synthetic speech signal. The synthetic speech signal may comprise a signal to be used as a voice biometric speech sample.

Another embodiment according to the invention is a computerized method of determining whether a speech signal is a natural human speech signal or a synthetic speech signal. The method comprises, with a machine recipient of the speech signal, the machine recipient being in possession of an audio watermark key, determining absence or presence of an audio watermark signal embedded into the speech signal based on the audio watermark key; and, based on a determined absence of the audio watermark signal, distinguishing the speech signal as being a natural human speech signal or, based on a determined presence of the audio watermark signal, distinguishing the speech signal as being a synthetic speech signal. The audio watermark signal to be detected is imperceptible by natural human audio perception of the synthetic speech signal with the embedded audio watermark signal.

In further, related embodiments, the computerized method may further comprise authorizing access or denying access based on the determined absence or presence of the audio watermark signal; such as authorizing access or denying access to a system protected by voice biometrics, the speech signal having been presented as a voice biometric sample; or, authorizing access or denying access to an Interactive Voice Response (IVR) system based on the determined absence or presence of the audio watermark signal. The speech signal may comprise a text-to-speech (TTS) synthesized signal. The audio watermark signal may be embedded into the speech signal based on a phonetic content of the speech signal. The audio watermark signal may be embedded into the speech signal: (i) in a pitch synchronous pattern based on at least one pitch period of the speech signal, and wherein the audio watermark key comprises the pitch synchronous pattern or comprises information with which the pitch synchronous pattern can be derived or reconstructed; or (ii) based on a spectral pattern, and wherein the audio watermark key comprises the spectral pattern or comprises information with which the spectral pattern can be derived or reconstructed; or (iii) based on a frequency hopping sequence, and wherein the audio watermark key comprises the frequency hopping sequence or comprises information with which the frequency hopping pattern can be derived or reconstructed. The audio watermark signal may comprise data regarding a source of the speech signal.

Another embodiment according to the invention is a system for processing a synthetic speech signal to facilitate distinguishing of the synthetic speech signal from a natural human speech signal. The system comprises an audio watermark processor configured to, during or after generating the synthetic speech signal, automatically embed an audio watermark signal into the synthetic speech signal based on an audio watermark key to thereby permit distinguishing of the synthetic speech signal from a natural human speech signal when the audio watermark signal is detected by a machine recipient of the synthetic speech signal in possession of the audio watermark key. The audio watermark signal is imperceptible by natural human audio perception of the synthetic speech signal with the embedded audio watermark signal.

In further, related embodiments, the audio watermark processor may be configured to embed the audio watermark signal into the synthetic speech signal by: (i) embedding the audio watermark signal in a pitch synchronous pattern based on at least one pitch period of the synthetic speech signal, and wherein the audio watermark key comprises the pitch synchronous pattern or comprises information with which the pitch synchronous pattern can be derived or reconstructed; (ii) embedding the audio watermark signal into the synthetic speech signal based on a spectral pattern, and wherein the audio watermark key comprises the spectral pattern or comprises information with which the spectral pattern can be derived or reconstructed; or (iii) embedding the audio watermark signal into the synthetic speech signal based on a frequency hopping sequence, and wherein the audio watermark key comprises the frequency hopping sequence or comprises information with which the frequency hopping pattern can be derived or reconstructed. The system may further comprise an information content scaling processor configured to vary an information content of the audio watermark signal based on at least one of an information content of the synthetic speech signal, a length of the synthetic speech signal, and a quality of the synthetic speech signal.

A further embodiment according to the invention is a non-transitory computer-readable medium configured to store instructions for processing a synthetic speech signal to facilitate distinguishing of the synthetic speech signal from a natural human speech signal, the instructions, when loaded and executed by a processor, cause the processor to process the synthetic speech signal to facilitate distinguishing of the synthetic speech signal from a natural human speech signal by: during or after generating the synthetic speech signal, automatically embedding an audio watermark signal into the synthetic speech signal based on an audio watermark key to thereby permit distinguishing of the synthetic speech signal from a natural human speech signal when the audio watermark signal is detected by a machine recipient of the synthetic speech signal in possession of the audio watermark key; wherein the audio watermark signal is imperceptible by natural human audio perception of the synthetic speech signal with the embedded audio watermark signal.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a schematic block diagram of a system for processing a synthetic speech signal to facilitate distinguishing of the synthetic speech signal from a natural human speech signal, in accordance with an embodiment of the invention.

FIG. 2 is a schematic block diagram of an audio watermark processor that is configured to embed an audio watermark signal into a synthetic speech signal using any of a variety of different possible audio watermark keys, in accordance with an embodiment of the invention.

FIGS. 3A and 3B are schematic block diagrams illustrating an information content scaling processor in an audio watermark processor, in accordance with an embodiment of the invention.

FIG. 4 is a schematic block diagram of a computerized method of determining whether a speech signal is a natural human speech signal or a synthetic speech signal, and of denying access or authorizing access to system based on that determination, in accordance with an embodiment of the invention.

FIG. 5 illustrates a computer network or similar digital processing environment in which embodiments of the present invention may be implemented.

FIG. 6 is a diagram of an example internal structure of a computer (e.g., client processor/device or server computers) in the computer system of FIG. 5.

### DETAILED DESCRIPTION

A description of example embodiments follows.

In accordance with an embodiment of the invention, an audio watermark is embedded in synthetic speech, such as synthetic speech created using text-to-speech (TTS) synthesis. Such audio watermarks can, for example, be used to increase the accuracy of voice biometric (VB) and other systems in distinguishing synthetic speech from human speech. This will be increasingly important as deep learning-based TTS systems reach human quality. In addition to its use in voice biometrics, such audio watermarking can prevent misuse of human quality TTS, or other synthetic speech, in a variety of other contexts, such as incriminating recordings, spam messages, contact center denial of service, and protection of personal information in contact centers not utilizing VB.

In embodiments, audio watermarking can be used to prevent misuse of text-to-speech (TTS) synthetic speech signals for voice biometric (VB) systems or other voice applications. In addition, embodiments can determine the amount of information in the audio watermark versus the length and quality of the audio; and can make the watermark robust to signal manipulation, such as compression, noise addition, or other signal manipulations. Embodiments can increase the accuracy of methods to distinguish TTS from human speech.

The security threat posed by TTS to user impersonation aligns with a wider public concern regarding the negative impacts of artificial intelligence. Audio watermarking of TTS and other synthetic speech in accordance with embodiments, if widely accepted by TTS technology providers and regulators, can potentially help to mitigate threats to voice biometrics systems and prevent fraud damage to VB customers.

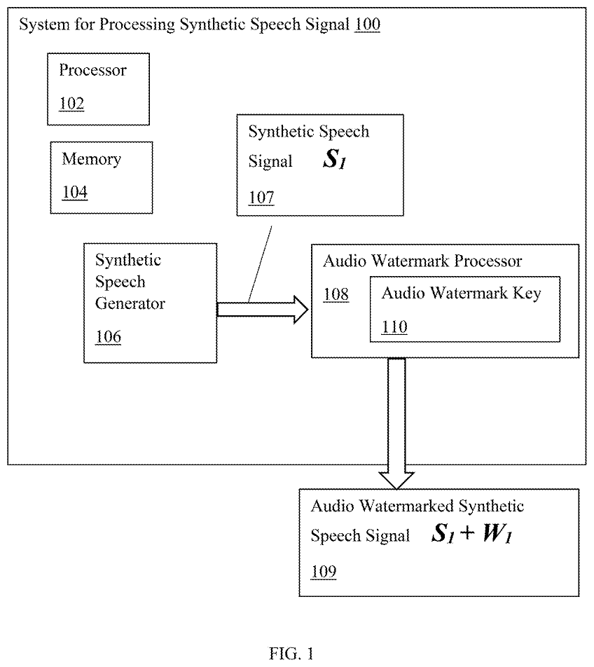

FIG. 1 is a schematic block diagram of a system 100 for processing a synthetic speech signal 107 (symbolized here as S₁), to facilitate distinguishing of the synthetic speech signal 107 from a natural human speech signal, in accordance with an embodiment of the invention. The synthetic speech signal 107 can, for example, comprise a text-to-speech (TTS) synthesized signal, although in other examples the synthetic speech signal 107 can be another type of synthetic speech signal. Synthetic speech signals used in embodiments according to the invention can also, for example, be recorded speech signals, or synthetic speech signals created by voice transformation, any of which can be watermarked with an audio watermark signal as with other embodiments described herein. In one example of a synthetic speech signal created by voice transformation, a spectral mapping is learned between the perpetrator and target such that the perpetrator can then speak a phrase, such as “my voice is my password,” and transform this phrase to have similar spectral characteristics to that of the target.

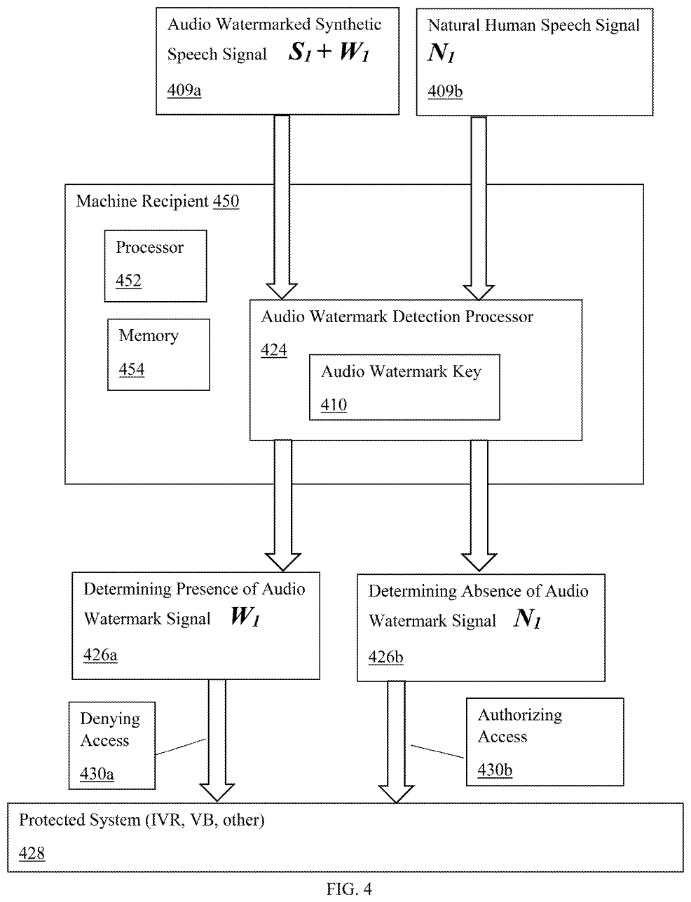

In the embodiment of FIG. 1, the system 100 comprises a processor 102, and a memory 104 with computer code instructions stored thereon. The processor 102 and the memory 104, with the computer code instructions, are configured to implement an audio watermark processor 108. The audio watermark processor 108 is configured to, during or after generating the synthetic speech signal 107, automatically embed an audio watermark signal (symbolized here as W₁) into the synthetic speech signal 107 based on an audio watermark key 110. For example, the audio watermark processor 108 can add the audio watermark signal, W₁, to the output of a synthetic speech generator 106, such as a text-to-speech (TTS) synthesis system, either during or after its generation of the synthetic speech signal 107, S₁. The result is an audio watermarked synthetic speech signal 109 (symbolized here as S₁+W₁). By the embedding of the audio watermark signal W₁, the system thereby permits distinguishing of the synthetic speech signal 107 from a natural human speech signal when the audio watermark signal W₁ is detected by a machine recipient 450 (see FIG. 4) of the synthetic speech signal, S₁+W₁, that is in possession of the same audio watermark key (110/410, see FIGS. 1 and 4). The audio watermark signal, W₁, is imperceptible by natural human audio perception of the synthetic speech signal with the embedded audio watermark signal, S₁+W₁. This can, for example, prevent the audio watermarking from noticeably degrading the speech signal, while also preventing malicious actors who are not in possession of the audio watermark key 110 from detecting and removing the audio watermark signal.

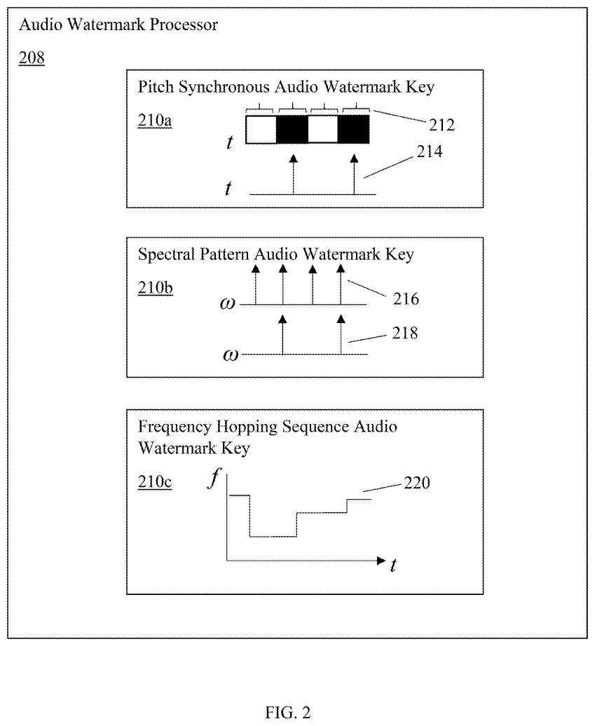

FIG. 2 is a schematic block diagram of an audio watermark processor 208 that is configured to embed an audio watermark signal into a synthetic speech signal using any of a variety of different possible audio watermark keys, 210a, 210b, 210c, in accordance with an embodiment of the invention. It will be appreciated that a variety of different possible alternative audio watermark keys can be used, and that an audio watermark processor 208 can, for example, use a single fixed audio watermark key, a choice of multiple different possible audio watermark keys, for example in a pattern of use of different audio watermark keys based on an algorithm known to both sender and recipient, or other manners of selecting an audio watermark key 210a, 210b, 210c.

The audio watermark signal can, for example, be embedded based on phonetic content of the synthetic speech signal, thereby exploiting knowledge about phonetic segments in the synthetic speech signal that is already available in the synthetic speech system (e.g., a TTS system), or that can be easily generated. For example, the audio watermark can be embedded around plosives, or to exploit psychoacoustic effects, such as effects relating to silence, voiced and unvoiced sounds, pitch, harmonics, or another choice of audio watermarking strategy based on phonetics.

In one example in FIG. 2, the audio watermark processor 208 can be configured to embed the audio watermark signal into the synthetic speech signal by embedding the audio watermark signal in a pitch synchronous pattern 214 based on at least one pitch period 212 of the synthetic speech signal. As noted, information regarding pitch periods 212 is already available to the synthetic speech system, or can be easily generated. In this example, the audio watermark key 210a comprises the pitch synchronous pattern 214, symbolized in FIG. 2 by the two watermark signal pulses 214 at synchronous locations with the pitch periods 212 filled in black in FIG. 2. In this way, the audio watermark signal can be rendered less perceptible by a malicious actor, by having the audio watermark signal's energy coincide with pitch periods 212 that tend to render the audio watermark signal less perceptible, for example.

In another example in FIG. 2, the audio watermark signal can be embedded into the synthetic speech signal based on a spectral pattern 218. For example, spectral pattern 218 comprises the second and fourth regions of the four spectral regions 216 of the synthetic speech signal (as a symbolic illustration), and a spectral pattern known by both the sender and the recipient of the synthetic speech signal can assist in rendering the audio watermark signal less perceptible. Here, the audio watermark key 210b comprises the spectral pattern 218. The spectral pattern 218 can, for example, be a spread spectrum pattern; and it can resemble noise. This method can, for example, be suitable for TTS systems that use spectral patterns as an intermediate representation, such as parametric TTS systems and waveform generation systems.

While phonetic, pitch synchronous, and spectral information are often readily available in a synthetic speech system, such as a TTS system, the receiving machine would typically not have this information. So, in some cases, the recipient machine would either need to derive this information or reconstruct the audio watermark signal without it. In some cases, the specific manner of embedding of the audio watermark signal within a given synthetic speech signal can be one that is reconstructed or derived by using a combination of the audio watermark key with the received synthetic speech signal itself. For example, where the audio watermark key is a pitch synchronous pattern or a spectral pattern, the specific manner of embedding of the audio watermark signal will depend on the specific pitch patterns and spectral patterns that are found in the synthetic speech signal itself, which the processor of the machine recipient can analyze and determine, and then apply a general pattern known in the audio watermark key that the authorized machine recipient possesses to determine the specific manner in which the audio watermark signal was embedded. For example, processor 452 can implement audio watermark detection processor 424 (see FIG. 4) to, first, analyze the received synthetic speech signal 409a to determine its pitch pattern 212 (see FIG. 2), and to then apply a general pattern of a pitch synchronous audio watermark key 214 that the processor 452 possesses (e.g., a general audio watermark key pattern 214 of the “second and fourth pitch periods of a sequence of four received pitch periods”) to determine the specific manner in which the audio watermark signal was stored within the given received synthetic speech signal.

In another example in FIG. 2, the audio watermark signal can be embedded into the synthetic speech signal based on a frequency hopping sequence 220, in which a frequency used for the audio watermark signal is changed over time in a hopping sequence known to both sender and recipient. Here, the audio watermark key 210 comprises the frequency hopping sequence. It will be appreciated that a variety of other possible different audio watermark keys 210a, 210b, 210c can be used.

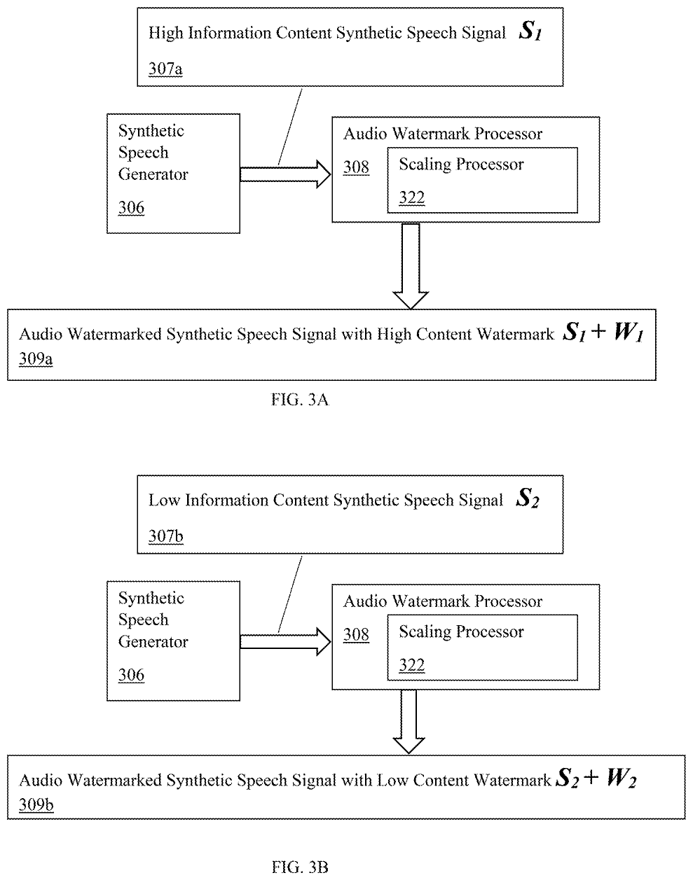

FIGS. 3A and 3B are schematic block diagrams illustrating an information content scaling processor 322 in an audio watermark processor 308, in accordance with an embodiment of the invention. Here, the scaling processor 322 is configured to vary an information content of the audio watermark signal based on at least one of an information content of the synthetic speech signal, a length of the synthetic speech signal, and a quality of the synthetic speech signal. For example, in FIG. 3A, upon determining that a synthetic speech signal, S₁, 307a, received from (or being created by) a synthetic speech generator 306, has a high information content, long length and/or high quality, the scaling processor 322 of the audio watermark processor 308 scales the audio watermark, W₁, accordingly. Thus, the audio watermarked synthetic speech signal, S₁+W₁, 309a, will be scaled by the scaling processor 322 to have a correspondingly high information content, long length and/or high quality, in such a situation.

By contrast, in FIG. 3B, upon determining that a synthetic speech signal, S₂, 307b, received from (or being created by) a synthetic speech generator 306, has a low information content, short length and/or low quality, the scaling processor 322 of the audio watermark processor 308 scales the audio watermark, W₂, accordingly. Thus, the audio watermarked synthetic speech signal, S₂+W₂, 309b, will be scaled by the scaling processor 322 to have a correspondingly low information content, short length and/or low quality, in such a situation.

In one example, a voice biometric application may be limited to using only several seconds of speech for a voice biometric comparison, in which case a sufficiently short audio watermark can be used. In another example, where there is sufficient information content in the audio watermark, the audio watermark signal can comprise data regarding a source of the synthetic speech signal. Here, a “source” of the synthetic speech signal is intended to signify, for example, a software product, or manufacturer of the software product, that created the synthetic speech signal, for example so that a manufacturer of a synthetic speech generator can determine when there is improper use of its systems.

FIG. 4 is a schematic block diagram of a computerized method of determining whether a speech signal is a natural human speech signal or a synthetic speech signal, and of denying access or authorizing access to system based on that determination, in accordance with an embodiment of the invention. A machine recipient 450 of the speech signal, 409a or 409b, is in possession of the audio watermark key 410, which is the same audio watermark key 110 (FIG. 1) used by the sender when sending a synthetic speech signal, S₁. Initially, the machine recipient 450 has not determined whether the received speech signal is an audio watermarked synthetic speech signal, S₁+W₁, 409a, or a natural human speech signal, N₁, 409b. The machine recipient 450 includes (or is in communication with) an audio watermark detection processor 424, implemented by a processor 452 based on computer code instructions stored in a memory 454. Using the audio watermark detection processor 424, the machine recipient 450 determines absence or presence of an audio watermark signal, W₁, embedded into the speech signal, based on the audio watermark key 410. Based on a determined absence 426b of the audio watermark signal, the machine recipient 450 distinguishes the speech signal as being a natural human speech signal, N₁. Alternatively, based on a determined presence 426a of the audio watermark signal, the speech signal is distinguished as being a synthetic speech signal. The machine recipient 450 can then authorize access 430b or deny access 430a to a protected system 428 based on the determined absence 426b or presence 426a of the audio watermark signal, W1. For example, access can be authorized or denied to a system 428 protected by voice biometrics, the speech signal having been presented as a voice biometric sample; or, access can be authorized or denied to an Interactive Voice Response (IVR) system 428 based on the determined absence or presence of the audio watermark signal.

Here, it should be appreciated that processing a watermark and a speech signal to authorize or deny access need not be performed in series, but can also be performed in parallel, to prevent latency issues, with authorization of access only being given upon completion of parallel processing; or using other combinations of series/parallel processing of the audio watermark with the speech signal.

In other cases, it may be desirable to permit access to a system for some synthetic speech signals (e.g., sent by a “safe” sender), but not for others (e.g., malicious senders), for example based on information regarding the origin of the speech that can be embedded in the audio watermark signal.

In another embodiment, the audio watermark signal can be robust to a level of degradation of the audio watermark signal that is greater than a level of degradation permitted for recognition of the synthetic speech signal by the machine recipient. For example, a malicious actor may attempt to impede operation of the audio watermarking by introducing a level of degradation, D₁, into the audio watermarked synthetic speech signal 409a, S₁+W₁, so that the watermark, W₁, is sufficiently degraded in quality that it is not recognized by the audio watermark detection processor 424. Degradation could, for example, be noise, compression, or another sort of degradation of the signal 409a. In order to defeat such attempts, the audio watermark signal, W₁, can be made robust to a level of degradation, D₁, such that the level of degradation D₁ is greater than that permitted for recognition of the synthetic speech signal by the machine recipient 450. For example, a voice biometric sample S₁ itself could be rendered unintelligible by degradation D₁, when degraded to S₁− D₁, while the watermarked signal, W₁, is still sufficiently robust when the watermarked speech signal is degraded to W₁− D₁ to be recognized as the audio watermark by the audio watermark detection processor 424.

As used herein, an “audio watermark signal” is an additional audio signal embedded into a synthetic speech signal based on an algorithm that may be generally available, but for which an audio watermark key is assumed to be possessed by authorized senders and recipients of the audio watermarked synthetic speech signal. As used herein, an “audio watermark key” is data that provides information, or that encodes information, on how an audio watermark signal is embedded within the synthetic speech signal. In some cases, the specific manner of embedding of the audio watermark signal within a given synthetic speech signal can be one that is reconstructed or derived by using a combination of the audio watermark key with the received synthetic speech signal itself. For example, where the audio watermark key is a pitch synchronous pattern or a spectral pattern, the specific manner of embedding of the audio watermark signal will depend on the specific pitch patterns and spectral patterns that are found in the synthetic speech signal itself, which the processor of the machine recipient can analyze and determine, and then apply a general pattern known in the audio watermark key that the authorized machine recipient possesses to determine the specific manner in which the audio watermark signal was embedded. In some examples, the audio watermark key can be one or more of a pitch synchronous pattern, a spectral pattern, a frequency hopping sequence or another manner of embedding an audio watermark signal in a synthetic speech signal, or can be information with which such patterns and sequences can be derived or reconstructed. The audio watermark key can, for example, be distributed and shared upon provision of a desired degree of proof of authorization to possess the audio watermark key, such as by authorized purchasers of synthetic speech generation and detection systems.

In an embodiment according to the invention, processes described as being implemented by one processor may be implemented by component processors configured to perform the described processes. Such component processors may be implemented on a single machine, on multiple different machines, in a distributed fashion in a network, or as program module components implemented on any of the foregoing. In addition, systems such as the system for processing a synthetic speech signal 100, the audio watermark processor 208, the machine recipient 450 and the audio watermark detection processor 424, and their components, can likewise be implemented on a single machine, on multiple different machines, in a distributed fashion in a network, or as program module components implemented on any of the foregoing. In addition, such components can be implemented on a variety of different possible devices. For example, the system for processing a synthetic speech signal 100, the audio watermark processor 208, the machine recipient 450 and the audio watermark detection processor 424, and their components, can be implemented on devices such as mobile phones, desktop computers, Internet of Things (IoT) enabled appliances, networks, cloud-based servers, or any other suitable device, or as one or more components distributed amongst one or more such devices. In addition, devices and components of them can, for example, be distributed about a network or other distributed arrangement.

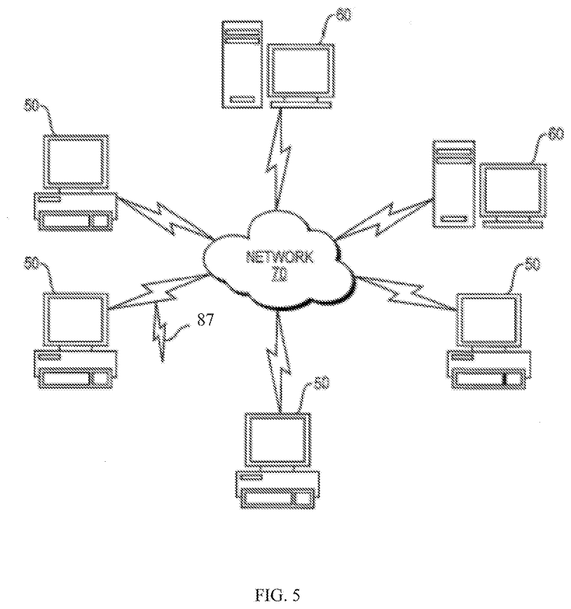

FIG. 5 illustrates a computer network or similar digital processing environment in which embodiments of the present invention may be implemented. Client computer(s)/devices 50 and server computer(s) 60 provide processing, storage, and input/output devices executing application programs and the like. The client computer(s)/devices 50 can also be linked through communications network 70 to other computing devices, including other client devices/processes 50 and server computer(s) 60. The communications network 70 can be part of a remote access network, a global network (e.g., the Internet), a worldwide collection of computers, local area or wide area networks, and gateways that currently use respective protocols (TCP/IP, Bluetooth®, etc.) to communicate with one another. Other electronic device/computer network architectures are suitable.

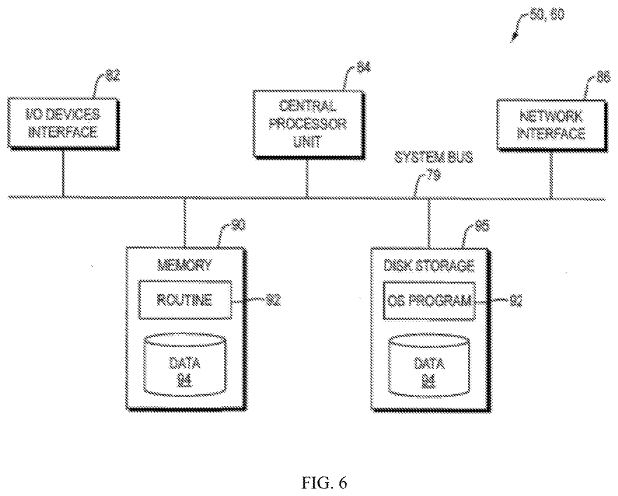

FIG. 6 is a diagram of an example internal structure of a computer (e.g., client processor/device 50 or server computers 60) in the computer system of FIG. 5. Each computer 50, 60 contains a system bus 79, where a bus is a set of hardware lines used for data transfer among the components of a computer or processing system. The system bus 79 is essentially a shared conduit that connects different elements of a computer system (e.g., processor, disk storage, memory, input/output ports, network ports, etc.) that enables the transfer of information between the elements. Attached to the system bus 79 is an I/O device interface 82 for connecting various input and output devices (e.g., keyboard, mouse, displays, printers, speakers, etc.) to the computer 50, 60. A network interface 86 allows the computer to connect to various other devices attached to a network (e.g., network 70 of FIG. 5). Memory 90 provides volatile storage for computer software instructions 92 and data 94 used to implement an embodiment of the present invention (e.g., the system for processing a synthetic speech signal 100, the audio watermark processor 208, the machine recipient 450 and the audio watermark detection processor 424). Disk storage 95 provides non-volatile storage for computer software instructions 92 and data 94 used to implement an embodiment of the present invention. A central processor unit 84 is also attached to the system bus 79 and provides for the execution of computer instructions.

In one embodiment, the processor routines 92 and data 94 are a computer program product (generally referenced 92), including a non-transitory computer-readable medium (e.g., a removable storage medium such as one or more DVD-ROM's, CD-ROM's, diskettes, tapes, etc.) that provides at least a portion of the software instructions for the invention system. The computer program product 92 can be installed by any suitable software installation procedure, as is well known in the art. In another embodiment, at least a portion of the software instructions may also be downloaded over a cable communication and/or wireless connection. In other embodiments, the invention programs are a computer program propagated signal product embodied on a propagated signal 87 (see FIG. 5) on a propagation medium (e.g., a radio wave, an infrared wave, a laser wave, a sound wave, or an electrical wave propagated over a global network such as the Internet, or other network(s)). Such carrier medium or signals may be employed to provide at least a portion of the software instructions for the present invention routines/program 92.

In alternative embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer.

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

1. A computerized method of processing a synthetic speech signal to facilitate distinguishing of the synthetic speech signal from a natural human speech signal, the method comprising:
during or after generating the synthetic speech signal, automatically embedding an audio watermark signal into the synthetic speech signal based on an audio watermark key to thereby permit distinguishing of the synthetic speech signal from a natural human speech signal when the audio watermark signal is detected by a machine recipient of the synthetic speech signal in possession of the audio watermark key;
wherein the audio watermark signal is imperceptible by natural human audio perception of the synthetic speech signal with the embedded audio watermark signal;
the automatically embedding the audio watermark signal comprising one or more of:
(i) embedding the audio watermark signal in a pitch synchronous pattern based on at least one pitch period of the synthetic speech signal, and wherein the audio watermark key comprises the pitch synchronous pattern or comprises information with which the pitch synchronous pattern can be derived or reconstructed;
(ii) embedding the audio watermark signal into the synthetic speech signal based on a spectral pattern comprising at least one spectral region of the synthetic speech signal, and wherein the audio watermark key comprises the spectral pattern or comprises information with which the spectral pattern can be derived or reconstructed; and
(iii) embedding the audio watermark signal into the synthetic speech signal based on a frequency hopping sequence, and wherein the audio watermark key comprises the frequency hopping sequence or comprises information with which the frequency hopping pattern can be derived or reconstructed.

2. The computerized method of claim 1, wherein the synthetic speech signal comprises a text-to-speech (TTS) synthesized signal.

3. The computerized method of claim 1, wherein embedding the audio watermark signal further comprises embedding the audio watermark signal based on a phonetic content of the synthetic speech signal.

4. (canceled)

5. The computerized method of claim 1, wherein the audio watermark signal comprises data regarding a source of the synthetic speech signal.

6. The computerized method of claim 1, wherein the audio watermark signal is robust to a level of degradation of the audio watermark signal that is greater than a level of degradation permitted for recognition of the synthetic speech signal by the machine recipient.

7. The computerized method of claim 1, further comprising varying an information content of the audio watermark signal based on at least one of an information content of the synthetic speech signal, a length of the synthetic speech signal, and a quality of the synthetic speech signal.

8. The computerized method of claim 1, wherein the synthetic speech signal comprises a signal to be used as a voice biometric speech sample.

9. A computerized method of determining whether a speech signal is a natural human speech signal or a synthetic speech signal, the method comprising:
with a machine recipient of the speech signal, the machine recipient being in possession of an audio watermark key, determining absence or presence of an audio watermark signal embedded into the speech signal based on the audio watermark key; and
based on a determined absence of the audio watermark signal, distinguishing the speech signal as being a natural human speech signal or, based on a determined presence of the audio watermark signal, distinguishing the speech signal as being a synthetic speech signal;
wherein the audio watermark signal to be detected is imperceptible by natural human audio perception of the synthetic speech signal with the embedded audio watermark signal;
the audio watermark signal being embedded into the speech signal in one or more of:
(i) in a pitch synchronous pattern based on at least one pitch period of the speech signal, and wherein the audio watermark key comprises the pitch synchronous pattern or comprises information with which the pitch synchronous pattern can be derived or reconstructed;
(ii) based on a spectral pattern comprising at least one spectral region of the speech signal, and wherein the audio watermark key comprises the spectral pattern or comprises information with which the spectral pattern can be derived or reconstructed; and
(iii) based on a frequency hopping sequence, and wherein the audio watermark key comprises the frequency hopping sequence or comprises information with which the frequency hopping pattern can be derived or reconstructed.

10. The computerized method of claim 9, further comprising authorizing access or denying access based on the determined absence or presence of the audio watermark signal.

11. The computerized method of claim 10, further comprising authorizing access or denying access to a system protected by voice biometrics, the speech signal having been presented as a voice biometric sample.

12. The computerized method of claim 10, further comprising authorizing access or denying access to an Interactive Voice Response (IVR) system based on the determined absence or presence of the audio watermark signal.

13. The computerized method of claim 9, wherein the speech signal comprises a text-to-speech (TTS) synthesized signal.

14. The computerized method of claim 9, wherein the audio watermark signal is further embedded into the speech signal based on a phonetic content of the speech signal.

15. (canceled)

16. The computerized method of claim 9, wherein the audio watermark signal comprises data regarding a source of the speech signal.

17. A system for processing a synthetic speech signal to facilitate distinguishing of the synthetic speech signal from a natural human speech signal, the system comprising:
an audio watermark processor configured to, during or after generating the synthetic speech signal, automatically embed an audio watermark signal into the synthetic speech signal based on an audio watermark key to thereby permit distinguishing of the synthetic speech signal from a natural human speech signal when the audio watermark signal is detected by a machine recipient of the synthetic speech signal in possession of the audio watermark key;
wherein the audio watermark signal is imperceptible by natural human audio perception of the synthetic speech signal with the embedded audio watermark signal the audio watermark processor being configured to embed the audio watermark signal into the synthetic speech signal by one or more of:
(i) embedding the audio watermark signal in a pitch synchronous pattern based on at least one pitch period of the synthetic speech signal, and wherein the audio watermark key comprises the pitch synchronous pattern or comprises information with which the pitch synchronous pattern can be derived or reconstructed;
(ii) embedding the audio watermark signal into the synthetic speech signal based on a spectral pattern comprising at least one spectral region of the synthetic speech signal, and wherein the audio watermark key comprises the spectral pattern or comprises information with which the spectral pattern can be derived or reconstructed; and
(iii) embedding the audio watermark signal into the synthetic speech signal based on a frequency hopping sequence, and wherein the audio watermark key comprises the frequency hopping sequence or comprises information with which the frequency hopping pattern can be derived or reconstructed.

18. (canceled)

19. The system of claim 17, further comprising an information content scaling processor configured to vary an information content of the audio watermark signal based on at least one of an information content of the synthetic speech signal, a length of the synthetic speech signal, and a quality of the synthetic speech signal.

20. A non-transitory computer-readable medium configured to store instructions for processing a synthetic speech signal to facilitate distinguishing of the synthetic speech signal from a natural human speech signal, the instructions, when loaded and executed by a processor, cause the processor to process the synthetic speech signal to facilitate distinguishing of the synthetic speech signal from a natural human speech signal by:
during or after generating the synthetic speech signal, automatically embedding an audio watermark signal into the synthetic speech signal based on an audio watermark key to thereby permit distinguishing of the synthetic speech signal from a natural human speech signal when the audio watermark signal is detected by a machine recipient of the synthetic speech signal in possession of the audio watermark key;
wherein the audio watermark signal is imperceptible by natural human audio perception of the synthetic speech signal with the embedded audio watermark signal;
the automatically embedding the audio watermark signal comprising one or more of:
(i) embedding the audio watermark signal in a pitch synchronous pattern based on at least one pitch period of the synthetic speech signal, and wherein the audio watermark key comprises the pitch synchronous pattern or comprises information with which the pitch synchronous pattern can be derived or reconstructed;
(ii) embedding the audio watermark signal into the synthetic speech signal based on a spectral pattern comprising at least one spectral region of the synthetic speech signal, and wherein the audio watermark key comprises the spectral pattern or comprises information with which the spectral pattern can be derived or reconstructed; and
(iii) embedding the audio watermark signal into the synthetic speech signal based on a frequency hopping sequence, and wherein the audio watermark key comprises the frequency hopping sequence or comprises information with which the frequency hopping pattern can be derived or reconstructed.
